(19) United States
(12) Patent Application Publication
(10) Pub. No.: US 2014/0130171 A1
(43) Pub. Date: May 8, 2014

(54) METHOD AND SYSTEM OF PROCESSING APPLICATION SECURITY

(71) Applicant: INSTITUTE FOR INFORMATION INDUSTRY, Taipei (TW)

(72) Inventors: Shang-Lun CHIANG, Taipei City (TW); Fu-Chuan CHEN, Taipei City (TW); Ming-Cheng SHENG, Kaohsiung City (TW)

(73) Assignee: INSTITUTE FOR INFORMATION INDUSTRY, TAIPEI (TW)

(21) Appl. No.: 13/693,056

(22) Filed: Dec. 4, 2012

(30) Foreign Application Priority Data
Nov. 6, 2012 (TW) 101141162

(51) Int. Cl. G06F 21/57

(52) U.S. Cl. CPC G06F 21/577
USPC 726/25

(57) ABSTRACT

A method of processing application security for uses in a platform-as-a-service layer (PAAS layer) includes steps as follows. First, an application program is scanned to find out a vulnerable code segment. Then, when the vulnerable code segment isn't fixed through a security process, a secure code segment is weaved into this unfixed vulnerable code segment, so as to ensure the security of the application program. Moreover, a system of processing application security is also disclosed in specification.

### RELATED APPLICATIONS

This application claims priority to Taiwan Application Serial Number 101141162, filed Nov. 6, 2012, which is herein incorporated by reference.

### BACKGROUND

1. Technical Field

The present disclosure relates to network security technology, and more particularly, a method and a system of processing application security.

2. Description of Related Art

Cloud computing a network (such as the Internet)-based computation by which the shared hardware and/or software resources are delivered to computers and other devices as needed.

Cloud computing is a drastic revolution, just like the transition from mainframe computers to client-server in 1980's. Users are no longer required to understand the details of the infrastructure in the “cloud”, nor should they possess corresponding professional knowledge associated with the cloud. Also, it is not necessary for them to directly control the cloud. Cloud computing provides novel, internet-based IT service, usage and payment models, which usually involve providing dynamic, expendable functions that are often virtualized resources. Typical cloud computing provides generally provide common internet service application, such that the user may access the software and data stored on the server through applications (e.g., browsers) or other Web services.

Regarding the network safety, conventional technology would monitor the network of the user of the cloud system so as to filter and process the anticipated traffic patterns with security concerns. However, such conventional technology could not fix the security vulnerabilities in the client end. Also, using the filtering manner to monitor the network of the user end would substantially increase the network delay time.

In view of the foregoing, there exist problems and disadvantages in the current systems that await further improvement. However, those skilled in the art sought vainly for a solution. In order to solve or circumvent above problems and disadvantages, there an urgent need in the related field to ensure the security of the application program.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to a self information security detection and defense mechanism for a platform-as-a-service layer (PAAS layer) so as to ensure the security of the application program.

According to one embodiment of the present invention, a method of processing application security for uses in a platform-as-a-service layer, the method includes steps of: (a) scanning an application program to find out a vulnerable code segment, and (b) weaving a secure code segment into the vulnerable code segment when the vulnerable code segment isn't fixed through a security process.

The method further includes a step of determining whether a program code of the application program is updated. And the step (a) is performed whenever the program code of the application program is updated.

In above method, the step (a) includes a sub-step of dynamically analyzing whether the program code of the application program has the vulnerable code segment.

Additionally or alternatively, the step (a) includes a sub-step of statically analyzing whether the program code of the application program has the vulnerable code segment.

The step (b) includes a sub-step of utilizing an aspect-oriented programming to weave the secure code segment into the vulnerable code segment.

According to another embodiment of the present invention, a system of processing application security for uses in a platform-as-a-service layer, and the system includes a program analyzer and a program weaver. The program analyzer scans an application program to find out a vulnerable code segment. The program weaver weaves a secure code segment into the vulnerable code segment when the vulnerable code segment isn't fixed through a security process.

In above system, whenever a program code of the application program is updated, the program analyzer scans whether the application program has the vulnerable code segment.

In above system, the program analyzer dynamically analyzes whether the program code of the application program has the vulnerable code segment.

Additionally or alternatively, in above system, the program analyzer statically analyzes whether the program code of the application program has the vulnerable code segment.

The program weaver is based on an aspect-oriented programming to weave the secure code segment into the vulnerable code segment.

Technical advantages are generally achieved, by embodiments of the present invention, as follows:

1. The application security vulnerabilities are solved actually, and the developers can take control of the program code and gradually correct the application program; and

2. For ensuring the security of the application program, the secure code segment is weaved into the vulnerable code, without filtering data traffic through the network. In this way, the application security is secured actually, and therefore the efficiency of network usage is increased substantially.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a schematic diagram of a system of processing application security according to one embodiment of the present disclosure;

FIG. 2 is a block diagram of the system according to one embodiment of the present disclosure; and

FIG. 3 is a flow diagram of a method of processing application security according to one embodiment of the present disclosure.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

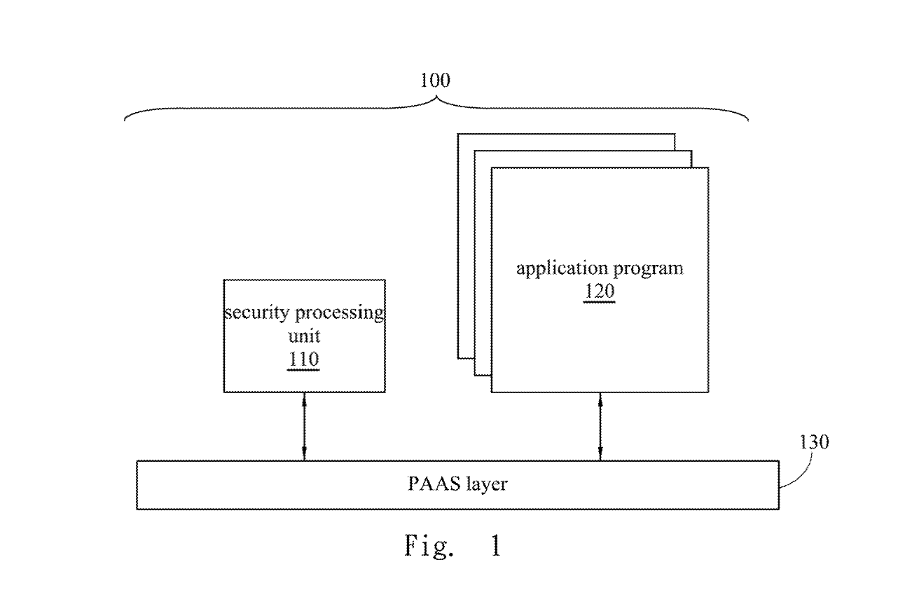

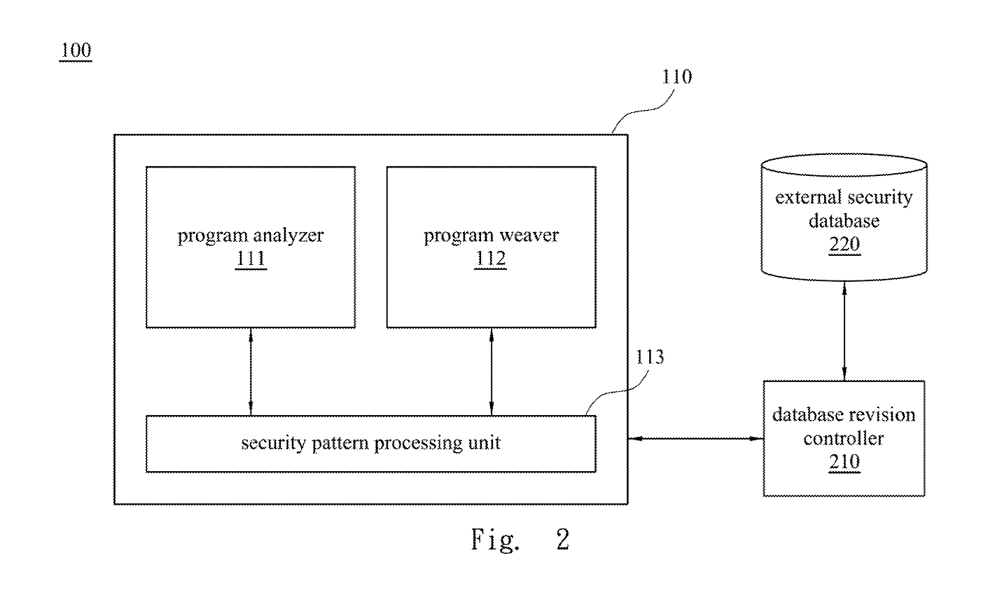

In one aspect, the present disclosure is directed to a system of processing application security for uses in a platform-as-a-service layer (PAAS layer), or the system may be widely used in other relevant technical fields. The specific embodiments exemplifying the system are described below in conjunction with FIG. 1 to FIG. 2.

FIG. 1 is a schematic diagram of a system 100 of processing application security according to one embodiment of the present disclosure. As illustrated in FIG. 1, the system 100 can be for uses in the PAAS layer 130. In use, the PAAS layer 130 can take control of the revision of an application program 120, provides a development-testing environment, and provides a flexible and high available production environment.

The system 100 includes a security processing unit 110. The security processing unit 110 scans the program code of the application program 120 to find out the security vulnerabilities whenever the application program 120 is updated, so that developers can fix a vulnerable code segment in the development-testing environment. The security processing unit 110 utilizes a software compilation to weave a secure code segment into an unfixed vulnerable code segment when the system is on-line, so as to ensure the security of the application program.

For a more complete understanding of the system 100, and the advantages thereof, refer to FIG. 2. FIG. 2 is a block diagram of the system according to one embodiment of the present disclosure. As illustrated in FIG. 2 the security processing unit 110 can be divided into a program analyzer 111, a program weaver 112 and a security pattern processing unit 113. The program analyzer 111 and the program weaver 112 are coupled with the security pattern processing unit 113.

In use, the program analyzer 111 scans the application program to find out the vulnerable code segment. When the application program has the vulnerable code segment, the security pattern processing unit 113 sends a notification or a solution to the developers through E-mail or the like, so that the developers can fix the vulnerable code segment in the development-testing environment. However, when the developers disregard or cannot fix the vulnerable code segment (i.e., when the vulnerable code segment isn't fixed through a security process), the program weaver 112 weaves the secure code segment into this unfixed vulnerable code, so as to ensure the security of the application program. Since the system 100 weaves the secure code segment into the vulnerable code, without filtering data traffic through the network, the application security is secured actually, and therefore the efficiency of network usage is increased substantially.

Moreover, the security pattern processing unit 113 is coupled with a database revision controller 210. The database revision controller 210 is coupled with an external security database 220. In use, this database 220 stores a code segment with security vulnerabilities (i.e. the vulnerable code segment), so that the security processing unit 110 has a source for inquiry. In other words, the database 220 may serve as a dictionary. The database revision controller 210 provides communication between the security processing unit 110 and the database 220, so that the security processing unit 110 can receive information about that the application program is weaved corresponding to a version of the database. Since the database is updated constantly, the security processing unit 110 merely continues to process the content that is not updated. The system 100 can detect the security vulnerabilities continually. Whenever the program code of the application program is updated, the program analyzer 111 scans whether the application program has the vulnerable code segment. Thus, the developers can take control of the program code and gradually correct the application program.

In order to really find out the vulnerabilities of the application program itself, the present invention uses a code analysis technology that can be divided into a dynamic analysis and a static analysis. In one embodiment, the program analyzer 111 dynamically analyzes whether the program code of the application program has the vulnerable code segment. In short, the dynamic analysis is to actually execute the application program for dynamically analyzing the application program. For example, test data are inputted to the application program, and then a result of executing the application program can be analyzed.

Furthermore, in the dynamic analysis, the application program can be executed in a virtual environment or a runtime environment. For example, the dynamic analysis can be utilized to analyze an interpretive program (i.e., Java application or the like) on a web page.

Compared with above dynamic analysis, in another embodiment, the program analyzer 111 statically analyzes whether the program code of the application program has the vulnerable code segment. In short, the static analysis is to perform a source code analysis on the application program without executing the application program. In practice, those with ordinary skill in the art may flexibly choose the dynamic or static analysis depending on the desired application.

Moreover, the present system utilizes an aspect-oriented programming technology for enhancing the application security. In one embodiment, the program weaver 112 is based on the aspect-oriented programming to weave the secure code segment into the unfixed vulnerable code, so as to establish a defense mechanism to prevent hack attack.

The program analyzer 111, the program weaver 112, the security pattern processing unit 113 and the database revision controller 210 may be hardware, software, and/or firmware. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The database 220 may be stored in different data storage devices or in the same data storage device, such as a computer hard disk, a server, an external hard disk, a keychain drive or another computer-readable storage medium.

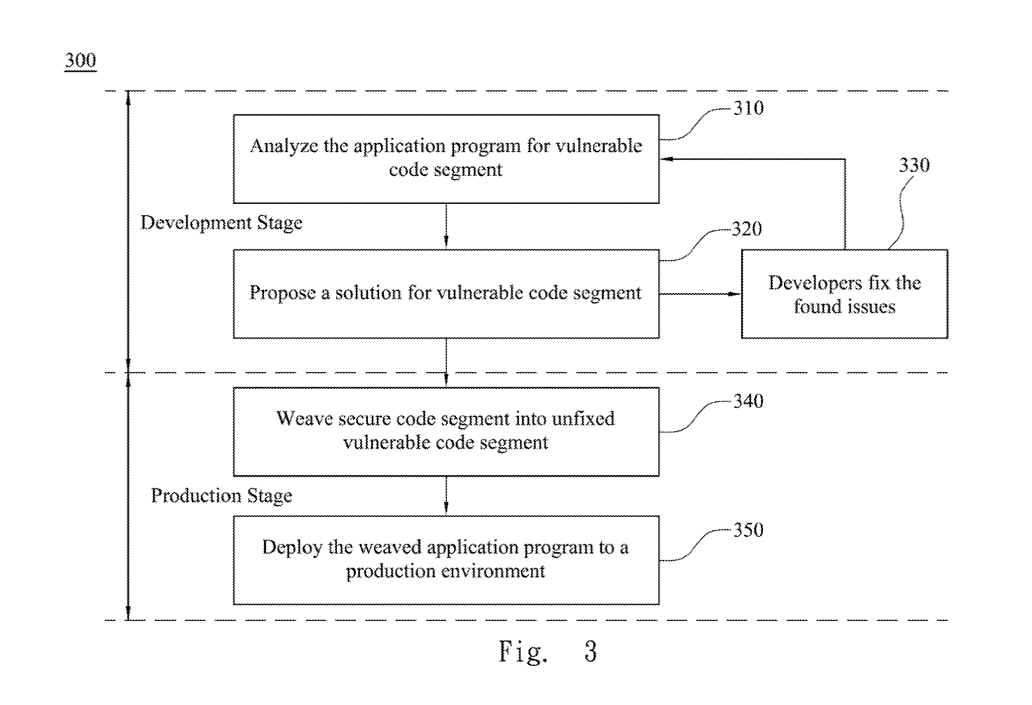

FIG. 3 is a flow diagram of a method 300 of processing application security according to one embodiment of the present disclosure. The method 300 can be used in the PAAS layer. The method 300 includes steps 310-350 as follows (The steps are not recited in the sequence in which the steps are performed. That is, unless the sequence of the steps is expressly indicated, the sequence of the steps is interchangeable, and all or part of the steps may be simultaneously, partially simultaneously, or sequentially performed). It should be noted that those implements to perform the steps in the method 300 are disclosed in above embodiments and, thus, are not repeated herein.

In a development stage, an application program is scanned in step 310 to find out a vulnerable code segment. In step 320, when the application program has the vulnerable code segment, a notification or a solution is sent to the developers through E-mail or the like. In step 330, the developers can fix the found issue (i.e., the vulnerable code segment) in the development-testing environment.

However, when the developers disregard or cannot fix the vulnerable code segment (i.e., when the vulnerable code segment isn't fixed through a security process), in a production stage, the secure code segment is weaved into this unfixed vulnerable code in step 340, so as to ensure the security of the application program. Then, step 350 is to deploy this weaved application program to a production environment. Since the method 300 weaves the secure code segment into the vulnerable code, without filtering data traffic through the network, the application security is secured actually, and therefore the efficiency of network usage is increased substantially.

The method 300 can detect the security vulnerabilities continually. Specifically, in step 310, it is determined that whether a program code of the application program is updated; whenever the program code of the application program is updated, the program analyzer 111 scans whether the application program has the vulnerable code segment. Thus, the developers can take control of the program code and gradually correct the application program.

In order to really find out the vulnerabilities of the application program itself, the present invention uses a code analysis technology that can be divided into a dynamic analysis and a static analysis. In one embodiment, the step 310 is to dynamically analyze whether the program code of the application program has the vulnerable code segment. Additionally or alternatively, in another embodiment, the step 310 is to statically analyze whether the program code of the application program has the vulnerable code segment. In practice, those with ordinary skill in the art may flexibly choose the dynamic or static analysis depending on the desired application.

Moreover, the method 300 utilizes an aspect-oriented programming technology for enhancing the application security. In one embodiment, an aspect-oriented programming is utilized in step 340 to weave the secure code segment into the unfixed vulnerable code, so as to establish a defense mechanism to prevent hack attack.

The method 300 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 USC. §112, 6th paragraph.

What is claimed is:

1. A method of processing application security for uses in a platform-as-a-service layer, the method comprising steps of:
(a) scanning an application program to find out a vulnerable code segment; and
(b) weaving a secure code segment into the vulnerable code segment when the vulnerable code segment isn't fixed through a security process.

2. The method of claim 1, further comprising:
determining whether a program code of the application program is updated; and
performing the step (a) whenever the program code of the application program is updated.

3. The method of claim 2, wherein the step (a) comprises:
dynamically analyzing whether the program code of the application program has the vulnerable code segment.

4. The method of claim 2, wherein the step (a) comprises:
statically analyzing whether the program code of the application program has the vulnerable code segment.

5. The method of claim 1, wherein the step (b) comprises:
utilizing an aspect-oriented programming to weave the secure code segment into the vulnerable code segment.

6. A system of processing application security for uses in a platform-as-a-service layer, the system comprising:
a program analyzer for scanning an application program to find out a vulnerable code segment; and
a program weaver for weaving a secure code segment into the vulnerable code segment when the vulnerable code segment isn't fixed through a security process.

7. The system of claim 6, wherein whenever a program code of the application program is updated, the program analyzer scans whether the application program has the vulnerable code segment

8. The system of claim 7, wherein the program analyzer dynamically analyzes whether the program code of the application program has the vulnerable code segment.

9. The system of claim 7, wherein the program analyzer statically analyzes whether the program code of the application program has the vulnerable code segment.

10. The system of claim 6, wherein the program weaver is based on an aspect-oriented programming to weave the secure code segment into the vulnerable code segment.
